(19) United States
(12) Patent Application Publication
(10) Pub. No.: US 2026/0122262 A1
(43) Pub. Date: Apr. 30, 2026

(54) SIGNALING TO ACTIVATE PARAMETER UPDATES AT PICTURE LEVEL

(71) Applicant: InterDigital VC Holdings, Inc., Wilmington, DE (US)

(72) Inventors: Hyomin Choi, Sunnyvale, CA (US); Fabien Racape, San Francisco, CA (US); Syed Mateen Ul haq, Mountain View, CA (US)

(73) Assignee: InterDigital VC Holdings, Inc., Wilmington, DE (US)

(21) Appl. No.: 18/990,701

(22) Filed: Dec. 20, 2024

Related U.S. Application Data
(60) Provisional application No. 63/712,220, filed on Oct. 25, 2024.

(51) Int. Cl. H04N 19/44; H04N 19/136

(52) U.S. Cl. CPC H04N 19/44; H04N 19/136

(57) ABSTRACT

Systems, methods, and instrumentalities are configured for signaling to activate parameter updates at a picture level. A video decoding device may be configured to receive an indication that is included in a feature picture parameter set (FPPS). The device may determine, based on the indication, whether parameters in the FPPS are to be updated. The device may, based on the determination that the parameters are to be updated, update the parameters regardless of a use of temporal resampling.

### CROSS-REFERENCE TO RELATED APPLICATIONS

This application claims the benefit of provisional U.S. patent application No. 63/712,220, filed Oct. 25, 2024, the disclosure of which is incorporated herein by reference in its entirety.

### BACKGROUND

The present application is related to video coding systems that may be used to compress digital video signals, e.g., to reduce the storage and/or transmission bandwidth needed for such signals. Video coding systems may include, for example, block-based, wavelet-based, and/or object-based systems.

### SUMMARY

Systems, methods, and instrumentalities are configured for signaling to activate parameter updates at a picture level. A video decoding device may be configured to receive a parameter update indication in a feature picture parameter set (FPPS). The device may determine, based on the parameter update indication, whether parameters in the FPPS are to be updated. The device may, based on the determination that the parameters are to be updated, parse updated parameter values.

The device may, based on the parameter update indication indicating not to update the parameters, reconstruct a feature based on parameters associated with a previous picture. The device may determine, based on the parameter update indication, whether a restored feature refinement parameter is to be updated. The device may, based on the determination that the restored feature refinement parameter is to be updated, parse a restored feature updated parameter value. The device may reconstruct a feature based on the updated restored feature refinement parameter.

The device may determine, based on the parameter update indication, whether a fused feature refinement parameter is to be updated. The device may, based on the determination that the fused feature refinement parameter is to be updated, parse a fused feature updated parameter value. The device may reconstruct a feature based on the updated fused feature refinement parameter.

In examples, a video encoding device may be configured to determine whether parameters in a feature picture parameter set (FPPS) are to be updated. The device may, based on the determination to update the parameters, include in an FPPS a parameter update indication. The device may encode a feature based on the parameter update indication. The device may determine that the parameters are not to be updated. The device may encode a feature based on parameters associated with a previous picture.

The device may determine whether a restored feature refinement parameter is to be updated, and the parameter update indication may be included in the FPPS based further on the determination that the restored feature refinement parameter is to be updated. The device may determine whether a fused feature refinement parameter is to be updated, and the parameter update indication may be included in the FPPS based further on the determination that the fused feature refinement parameter is to be updated.

In examples, a video decoding device may be configured to receive a feature picture parameter set (FPPS). The device may determine, based on a feature refinement indication in a feature sequence parameter set (FSPS), whether parameters in the FPPS are present. The device may parse the parameters from the FPPS based on the feature refinement indication indicating that the parameters in the FPPS are present.

The device may determine, based on the parameter update indication, whether a dynamic range adjustment parameter is to be updated. Based on the determination that the dynamic range adjustment parameter is to be updated, the device may parse a dynamic range adjustment updated parameter value. The device may reconstruct a feature based on the updated dynamic range adjustment parameter.

The parameter update indication may include a first parameter update indication and a second parameter update indication, and the first parameter update indication and the second parameter update indication may be received separately.

The determination that the parameters are to be updated may include determining that a first parameter is to be updated based on the first parameter update indication and determining that second parameter is to be updated based on the second parameter update indication. Parsing the updated parameter values may include parsing a first updated parameter value associated with the first parameter and parsing a second updated parameter value associated with the second parameter.

In examples, a video encoding device may determine whether to include parameters in a feature picture parameter set (FPPS). The device may include the parameters in the FPPS in a feature refinement indication based on determining to include the parameters in the FPPS. The device may encode a feature based on the included parameters.

The device may determine that the parameters are not to be updated. The device may encode a feature based on parameters associated with a previous picture.

The device may determine whether a restored feature refinement parameter is to be updated. The parameter update indication may be included in the FPPS based further on the determination that the restored feature refinement parameter is to be updated.

The device may determine whether a fused feature refinement parameter is to be updated. The parameter update indication may be included in the FPPS based further on the determination that the fused feature refinement parameter is to be updated.

The device may determine whether a dynamic range adjustment parameter is to be updated. The parameter update indication may be included in the FPPS based further on the determination that the dynamic range adjustment parameter is to be updated.

Including the parameter update indication in the feature picture parameter set (FPPS) may include including a first parameter update indication and a second parameter update indication. The first parameter update indication and the second parameter update indication may be included separately.

Determining that the parameters are to be updated may include determining that a first parameter is to be updated and determining that a second parameter is to be updated. Including the parameter update indication in the FPPS may include including a first updated parameter value associated with the first parameter based on determining that the first parameter is to be updated and including a second updated parameter value associated with the second parameter based on determining that the second parameter is to be updated.

### BRIEF DESCRIPTION OF THE DRAWINGS

The following detailed description will be better understood when read in conjunction with the appended drawings, in which there are shown examples of one or more of the multiple embodiments of the present disclosure. It should be understood, however, that the embodiments described herein are not limited to the precise arrangements and instrumentalities shown in the drawings.

FIG. 1 shows an example system according to one or more embodiments of the present disclosure.

FIG. 2 shows an example video encoder according to one or more embodiments of the present disclosure.

FIG. 3 shows an example video decoder according to one or more embodiments of the present disclosure.

FIG. 4 shows an example video coding for machines pipeline.

FIG. 5 shows an example pipeline associated with video processing.

FIG. 6 shows an example region-based convolutional neural network (R-CNN) architecture.

FIG. 7 shows example shapes of tensors to transmit, considering a split point after a backbone network of an example R-CNN architecture.

FIG. 8 shows an example shallow network architecture for a feature reduction module interfacing with an example R-CNN at example feature pyramid network outputs P2, P3, P4, P5.

FIG. 9A shows an example feature conversion.

FIG. 9B shows an example inverse feature conversion.

FIG. 10 shows an example of tiled feature channels into a packed frame.

FIG. 11A shows an example of a coding sequence at the encoder and decoder when the temporal upsampling is disabled.

FIG. 11B shows an example of a coding sequence at the encoder and decoder when the temporal upsampling is enabled.

### DETAILED DESCRIPTION

In describing the various embodiments of the present disclosure, certain terminology is used herein for convenience only and should not be considered as limiting such embodiments. In the drawings, the same reference numerals are employed for designating the same elements throughout the several figures and the present description.

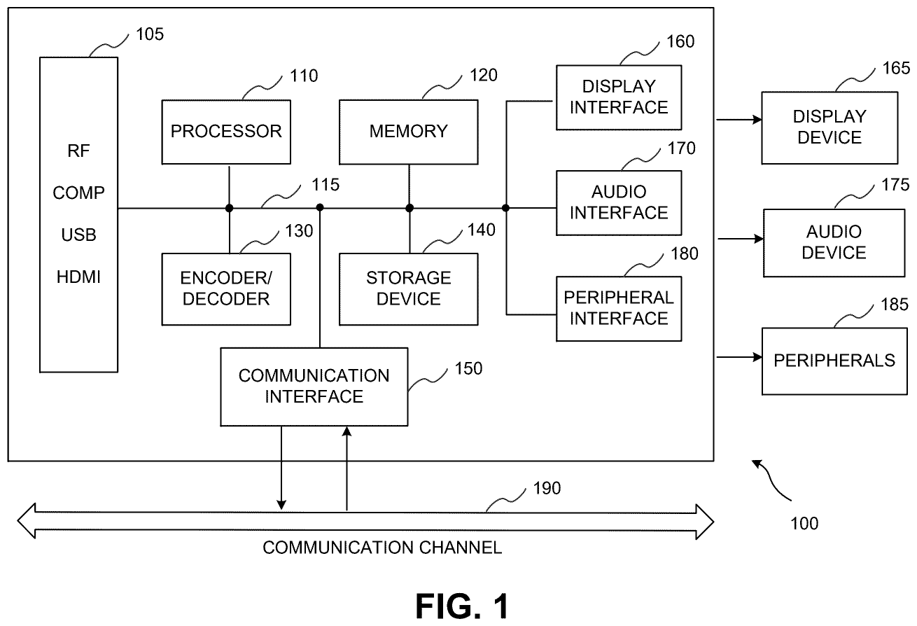

Referring to the drawings, there is shown in FIG. 1 a block diagram illustrating an example system 100 in which embodiments of the present disclosure can be implemented. The system 100 may be an electronic device including, for example, a personal computer, laptop computer, mobile phone, tablet computer, multimedia set-top box, digital television receiver, personal video recording system, connected home appliance, vehicle control and/or entertainment system, and server. One or more elements of the system 100, singly or in combination, may be implemented as an integrated circuit (IC), multiple ICs, and/or discrete components. For example, in one embodiment, the processing, encoding and/or decoding elements of system 100 are distributed across multiple ICs and/or discrete components. In some embodiments, the system 100 is communicatively coupled to and/or in communication with other systems or devices, via, for example, a communications bus or dedicated input/output ports.

One or more of the elements of system 100 may be provided within an integrated housing, with such elements being interconnected and able to transmit data therebetween using any suitable connection arrangement 115 generally known in the art, including, for example, an internal bus (e.g., 12C bus), wiring, and printed circuit boards.

The system 100 may include at least one processor 110 configured to execute instructions for implementing the embodiments described herein, including signal/data coding and processing. The processor 110 may be a general-purpose processor or microprocessor, digital signal processor (DSP), one or more microprocessors in association with a DSP core, a controller, a microcontroller, application specific integrated circuits (ASICs), field programmable gate arrays (FPGAs), a state machine, and the like. The processor 110 may include at least one central processing unit (CPU), embedded memory, input and output interfaces, and other circuitries.

The system 100 may include at least one memory 120, for example, a volatile memory device and/or a non-volatile memory device. The system 100 may include a storage device 140, that may be or include non-volatile memory and/or dynamic volatile memory, including EEPROM, ROM, PROM, RAM, DRAM, SRAM, DDR, flash, magnetic disk drives, solid state drives (SSD) and/or optical disk drives. The storage device 140 may be or include, for example, an internal storage device, an attached storage device, and/or a network accessible storage device. Although shown separately, the memory 120 and the storage device 140 may be collocated, integrated together, or otherwise combined.

The system 100 may include an encoder/decoder module 130 configured to process video data and to provide encoded video data or decoded video data. The encoder/decoder module 130 may include one or more processors and/or memory (not shown). Although FIG. 1 depicts the encoder/decoder module 130 as a separate element of system 100, it will be understood that the processor 110 and the encoder/decoder module 130 may be collocated and/or integrated together as a combination of hardware and/or software, e.g., in an electronic package or chip. The encoder/decoder module 130 may be or include one or more modules that may be included in one or more separate devices that perform encoding and/or decoding functions.

Instructions for execution by the processor 110 and/or the encoder/decoder module 130 may be stored in the storage device 140 and subsequently loaded into memory 120 for execution by the processor 110. In some embodiments, one or more of processor 110, memory 120, storage device 140, and encoder/decoder module 130 may store one or more items when performing the processes disclosed herein. Such items may include input video, decoded video or portions thereof, bitstreams, matrices, variables, operational logic, and intermediate and/or final results from processing of equations, formulas, or operations.

In some embodiments, the memory of the processor 110 and/or the encoder/decoder module 130 may be used to store instructions and/or provide working memory for video encoding and decoding functions. In some embodiments, memory external to the processor 110 and/or the encoder/decoder module 130 (e.g., the memory 120 and/or the storage device 140) may be used for one or more of these functions and/or, for example, to store the operating system of a television.

The system 100 may obtain or receive information via one or more input devices, interfaces, and/or ports as indicated in input block 105. Examples of the input devices include a radio frequency (RF) device for transmitting and/or receiving RF signals over various media, for example, RF signals received over the air from a broadcaster; component video (COMP) inputs; a Universal Serial Bus (USB) input; and/or a High-Definition Multimedia Interface (HDMI) input. Other examples include composite video input (not shown). In some embodiments, the input devices are associated with respective input processing elements, e.g., those generally known in the art. For example, the RF device may be associated with elements suitable for selecting a desired frequency (e.g., selecting or band-limiting a signal) or performing error correction on the signal. The USB and/or HDMI inputs may include respective interface processors and transceivers (or transmitters and receivers) for coupling the system 100 to other devices via USB and/or HDMI ports or connections. Various forms of input processing may be implemented, for example, by and/or within a separate input processing device or the processor 110.

The system 100 may include a communication interface 150 that enables wired and/or wireless communication with other devices, e.g., via a communication channel 190. The communication interface 150 may include one or more transceivers, modems, network cards and the like. The communication channel 190 may be or include wired and/or wireless mediums.

In some embodiments, data may be streamed to the system 100 via wired and/or wireless networks. Examples of such wireless networks include cellular, Bluetooth or Wi-Fi (e.g., IEEE 802.11) networks. The wired and/or wireless networks may include one or more base stations (e.g., cellular base stations, access points, etc.), and/or user equipment (e.g. cellular user equipment, stations, etc.), and/or other network elements that communicate with the system 100 via the communication interface 150 and communication channel 190, whereby the system 100 may obtain data streamed from streaming applications (e.g., OTT services) via various networks, including the Internet. In some embodiments, data is streamed to the system 100 via the input block 105 (e.g., using a set-top box that delivers data via the HDMI connection or the RF connection). In some embodiments, data is received by the system 100 in a non-streaming manner.

The system 100 may provide one or more output signals to one or more output devices. The output devices may include a display device 165 (e.g., touchscreen display, monitor, etc.), an audio device 175 (e.g., speakers), and other peripheral devices 185, including, for example, a stand-alone DVR, a disk player, a stereo system, a lighting system, and other devices that provide a function based on the output of the system 100. The display device 165 can be for a television, tablet, laptop, mobile phone, head-mounted display, or other device. In some embodiments, control signals are communicated between the system 100 and the display device 165, the audio device 175, and/or the peripheral devices 185, enabling device-to-device control with or without user intervention. The output devices may couple to and/or communicate with the system 100 via dedicated connections via respective display, audio, and peripheral interfaces 160, 170, 180. Alternatively, the output devices may couple to and/or communicate with the system 100 via the communication channel 190 and the communication interface 150.

The display device 165 and the audio device 175 may be collocated, integrated, or otherwise combined with the other components of system 100 in a single unit (e.g., a television). Alternatively, the display device 165 and the audio device 175 may be separate from one or more of the other components of the system 100. In embodiments in which the display device 165 and the audio device 175 are external components, the output signals may be provided via dedicated outputs and/or connections, including, for example, HDMI ports, USB ports, or COMP outputs.

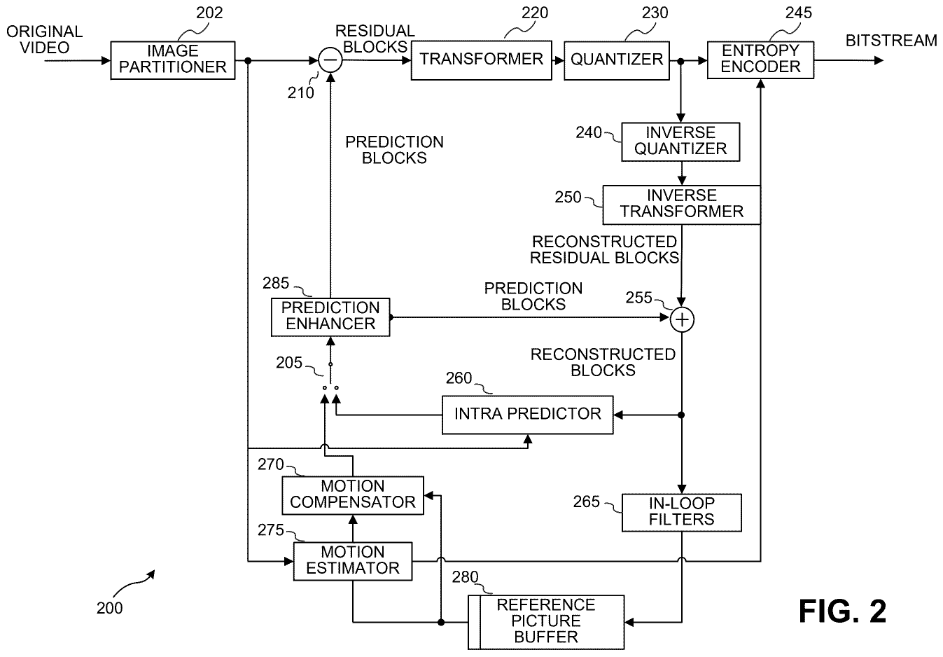

FIG. 2 is a block diagram illustrating an example video encoder 200 that may be employed by the system 100 (e.g., via the encoder/decoder module 130) described with respect to FIG. 1. The video encoder 200 may be an encoder that employs video compression technologies, standards, specification, or protocols, including Advanced Video Coding (AVC, H.264/MPEG-4), High Efficiency Video Coding (HEVC, H.265), Versatile Video Coding (VVC, H.266), Essential Video Coding (EVC, MPEG-5), AOMedia Video 1 (AV1), VP9, or the Enhanced Compression Model (ECM), and variations or improvements thereof. Those skilled in the art will understand that the various embodiments described herein are not limited to a specific standard and can be applied to other standards and recommendations, as well as extensions thereof.

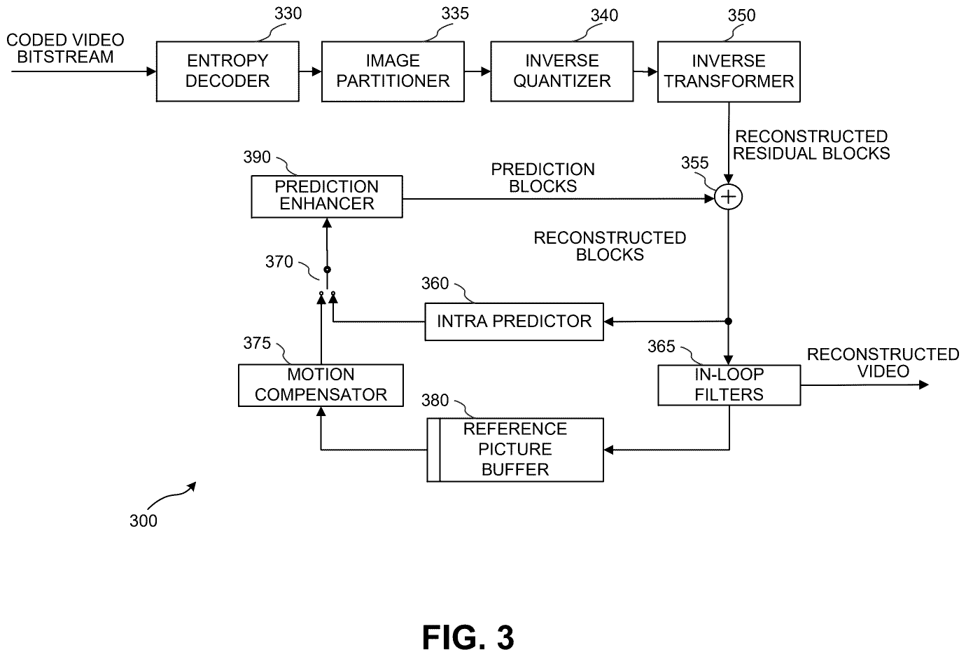

Some embodiments disclosed herein are described with reference to a coding unit (CU) or block of a video frame (or a video image or picture) to which coding tools may be applied by the video encoder 200 and/or by the video decoder 300 (described below with reference to FIG. 3). Generally, embodiments described herein may be applied to a video region formed by a video partition of any shape or size. The video region may be a video slice, a coding tree unit (CTU), or a CU (to which inter prediction or intra prediction can be applied), or a partition thereof, each of which can include samples of a luma component, Y, and chroma components, U and V (also denoted herein by C, Cb, Cr).

Referring generally to FIG. 2 and the video encoder 200, video data (e.g., one or more video frames) is encoded generally as described below. Prior to encoding, video data may be pre-processed by a precoding processor (not shown). The pre-processing may include, for example, applying a color model transform to the input color components of the input video data (e.g., conversion from RGB 4:4:4 to YUV 4:2:0) or mapping the color components of the input video data to obtain a signal distribution that is more resilient to compression (for instance, applying a histogram equalizer and/or a denoising filter to one or more of the video data's color components). The pre-processing may include associating metadata (for example, a supplemental enhancement information (SEI) message) with the video data that can be attached to a coded video bitstream. After pre-processing, if any, an image (frame) to be encoded is partitioned into CUs (blocks) by an image partitioner 202.

In general, a CU may include a luma block and associated chroma blocks. As such, functions of the video encoder 200 described herein as applied to a CU refer generally to the luma block and the respective chroma blocks. The CUs may be encoded using an intra prediction mode performed by an intra predictor 260. In intra prediction mode, the content of a CU in a frame is predicted based on content from one or more other CUs of the same frame (or region), using reconstructed blocks of other CUs output from an adder 255. The CUs may also or alternatively be encoded using an inter prediction mode, in which motion estimation and motion compensation are performed by a motion estimator 275 and a motion compensator 270, respectively. In inter prediction mode, the content of a CU in a frame is predicted based on content from one or more reconstructed areas of reference frames, available from a reference picture buffer 280.

The video encoder 200 selects or otherwise determines at 205 which prediction mode (intra prediction mode and/or inter prediction mode) to use for encoding a CU. The selected prediction mode may be enhanced (e.g., filtered) by a prediction enhancer 285. Based on the selected mode, a prediction for the CU is generated. A residual block is determined based on the prediction (e.g., prediction block, predicted CU) and the input CU. In some embodiments, such determination is made by a subtractor 210.

The residual block or a partition thereof (e.g., a transform block) is transformed into transform coefficients by a transformer 220. The transform coefficients are quantized by a quantizer 230. An entropy encoder 245 performs entropy encoding of the quantized transform coefficients and coding parameters (e.g., syntax elements including motion vectors and other control data) to form a bitstream of coded video data.

In addition to coding the original video blocks as described herein, the video encoder 200 reconstructs the coded blocks to provide references for future predictions. Thus, quantized transform coefficients (from the quantizer 230) are de-quantized by an inverse quantizer 240, and inverse transformed by an inverse transformer 250, to reconstruct (decode) the residual blocks. The reconstructed residual blocks and prediction blocks are combined (e.g., by the adder 255) to form reconstructed blocks. Thus, the video encoder 200 performs decoding operations through which the encoded images (frames) are reconstructed.

In-loop filters 265 may be applied to the reconstructed image (formed by the reconstructed blocks). The filtered reconstructed image(s) are stored in the reference picture buffer 280 and used by the motion estimator 275 and motion compensator 270, as explained above. The in-loop filters 265 can be applied to the reconstructed samples of an image to reduce distortions introduced by the encoding process. For example, a deblocking filter (DBF), bilateral filter (BIF), sample adaptive offset (SAO), and/or adaptive loop filter (ALF) can be applied to reduce encoding artifacts.

FIG. 3 is a block diagram illustrating an example of video decoder 300 that may be employed by the system 100 (e.g., via the encoder/decoder module 130) described with respect to FIG. 1. Generally, operational features of the video decoder 300 are reciprocal to operational features of the video encoder 200. In the video decoder 300, a coded video bitstream (e.g., generated by the video encoder 200 or another video encoding device or process) is entropy-decoded by an entropy decoder 330 to obtain transform coefficients, motion vectors, and other coding parameters. Based on the coding parameters, an image partitioner 335 divides the picture accordingly. The quantized transform coefficients are de-quantized by an inverse quantizer 340 and inverse transformed by an inverse transformer 350 to decode (e.g., reconstruct) respective residual blocks. Depending on the selected prediction mode, a predicted block can be obtained at 370 from an intra predictor 360 (e.g., intra prediction) or from a motion compensator 375 (e.g., inter prediction) and may be enhanced (e.g., filtered) by a prediction enhancer 390, generating a prediction block. The reconstructed residual blocks are combined with prediction blocks (e.g. by an adder 355), resulting in reconstructed blocks.

In-loop filters 365 (e.g., DBF, BIF, SAO, and/or ALF) can be applied to the reconstructed image (formed by the reconstructed blocks), to output reconstructed (decoded) video. The filtered reconstructed image is also stored in a reference picture buffer 380 for reference by the motion compensator 375.

A post-decoding processor (not shown) can process the reconstructed video data. For example, post-decoding processing can include an inverse color model transform (e.g., conversion from YUV 4:2:0 to RGB 4:4:4) or an inverse mapping to reverse the mapping process performed by the pre-encoding processor described with respect to FIG. 2. The post-decoding processor can use metadata derived by the pre-encoding processor and/or signaled in the video bitstream.

Systems, methods, and instrumentalities are configured for signaling to activate parameter updates at a picture level. A video decoding device may be configured to receive a parameter update indication in a feature picture parameter set (FPPS). The device may determine, based on the parameter update indication, whether parameters in the FPPS are to be updated. The device may, based on the determination that the parameters are to be updated, parse updated parameter values.

The device may, based on the parameter update indication indicating not to update the parameters, reconstruct a feature based on parameters associated with a previous picture. The device may determine, based on the parameter update indication, whether a restored feature refinement parameter is to be updated. The device may, based on the determination that the restored feature refinement parameter is to be updated, parse a restored feature updated parameter value. The device may reconstruct a feature based on the updated restored feature refinement parameter.

The device may determine, based on the parameter update indication, whether a fused feature refinement parameter is to be updated. The device may, based on the determination that the fused feature refinement parameter is to be updated, parse a fused feature updated parameter value. The device may reconstruct a feature based on the updated fused feature refinement parameter.

In examples, a video encoding device may be configured to determine whether parameters in a feature picture parameter set (FPPS) are to be updated. The device may, based on the determination to update the parameters, include in an FPPS a parameter update indication. The device may encode a feature based on the parameter update indication. The device may determine that the parameters are not to be updated. The device may encode a feature based on parameters associated with a previous picture.

The device may determine whether a restored feature refinement parameter is to be updated, and the parameter update indication may be included in the FPPS based further on the determination that the restored feature refinement parameter is to be updated. The device may determine whether a fused feature refinement parameter is to be updated, and the parameter update indication may be included in the FPPS based further on the determination that the fused feature refinement parameter is to be updated.

In examples, a video decoding device may be configured to receive a feature picture parameter set (FPPS). The device may determine, based on a feature refinement indication in a feature sequence parameter set (FSPS), whether parameters in the FPPS are present. The device may parse the parameters from the FPPS based on the feature refinement indication indicating that the parameters in the FPPS are present.

The device may determine, based on the parameter update indication, whether a dynamic range adjustment parameter is to be updated. Based on the determination that the dynamic range adjustment parameter is to be updated, the device may parse a dynamic range adjustment updated parameter value. The device may reconstruct a feature based on the updated dynamic range adjustment parameter.

The parameter update indication may include a first parameter update indication and a second parameter update indication, and the first parameter update indication and the second parameter update indication may be received separately.

The determination that the parameters are to be updated may include determining that a first parameter is to be updated based on the first parameter update indication and determining that second parameter is to be updated based on the second parameter update indication. Parsing the updated parameter values may include parsing a first updated parameter value associated with the first parameter and parsing a second updated parameter value associated with the second parameter.

In examples, a video encoding device may determine whether to include parameters in a feature picture parameter set (FPPS). The device may include the parameters in the FPPS in a feature refinement indication based on determining to include the parameters in the FPPS. The device may encode a feature based on the included parameters.

The device may determine that the parameters are not to be updated. The device may encode a feature based on parameters associated with a previous picture.

The device may determine whether a restored feature refinement parameter is to be updated. The parameter update indication may be included in the FPPS based further on the determination that the restored feature refinement parameter is to be updated.

The device may determine whether a fused feature refinement parameter is to be updated. The parameter update indication may be included in the FPPS based further on the determination that the fused feature refinement parameter is to be updated.

The device may determine whether a dynamic range adjustment parameter is to be updated. The parameter update indication may be included in the FPPS based further on the determination that the dynamic range adjustment parameter is to be updated.

Including the parameter update indication in the feature picture parameter set (FPPS) may include including a first parameter update indication and a second parameter update indication. The first parameter update indication and the second parameter update indication may be included separately.

Determining that the parameters are to be updated may include determining that a first parameter is to be updated and determining that a second parameter is to be updated. Including the parameter update indication in the FPPS may include including a first updated parameter value associated with the first parameter based on determining that the first parameter is to be updated and including a second updated parameter value associated with the second parameter based on determining that the second parameter is to be updated.

A computer program product which is stored on a non-transitory computer readable medium and may include program code instructions for implementing a method according to examples described herein when executed by a processor.

A computer program may include program code instructions for implementing steps of a method according to examples described herein when executed by a processor.

Video data may include information representative of the parameters according to examples described herein.

Examples described herein may be associated with split inference (e.g., collaborative intelligence), e.g., machine vision analytics such as classification, object detection, object tracking, etc. with split deep neural networks (DNN) that are physically apart from one another and communicate by transmitting intermediate data at the split point.

With machine learning technologies for vision applications in domains like intelligent transportation, smart cities, intelligent content management, etc., the amount of video and images consumed by machines may increase. In examples, vision tasks may use computations and perform on cloud systems and devices capturing the source content, which may transmit video content. For video transmission pipelines, the amount of source data may use compression to fit physical bandwidth and storage capacities. Examples described herein may be associated with image and video codecs associated with human consumption. Machine vision algorithms may (or may not) be sensitive to artifacts when applying lossy compression.

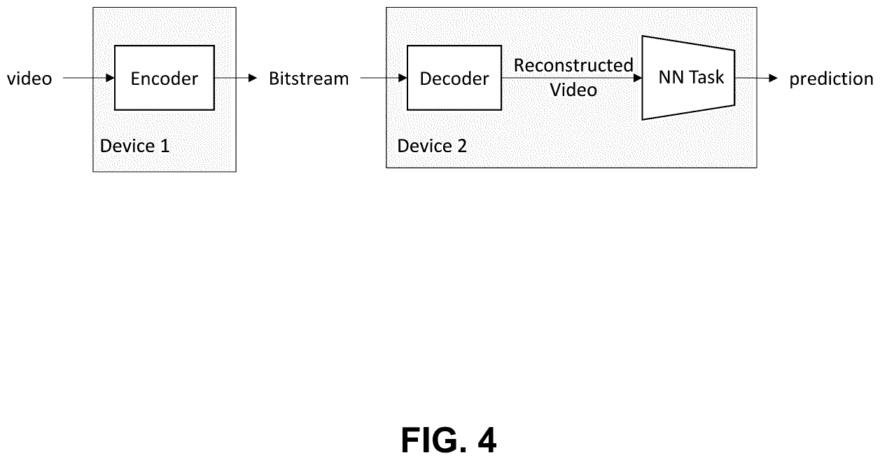

FIG. 4 shows an example video coding for machines pipeline. Enabling (e.g., efficient) remote analysis may include compressing the source videos for downstream vision tasks.

The term video may be used to describe image and video content. Examples described herein may be associated with and may be applied to image content and video content.

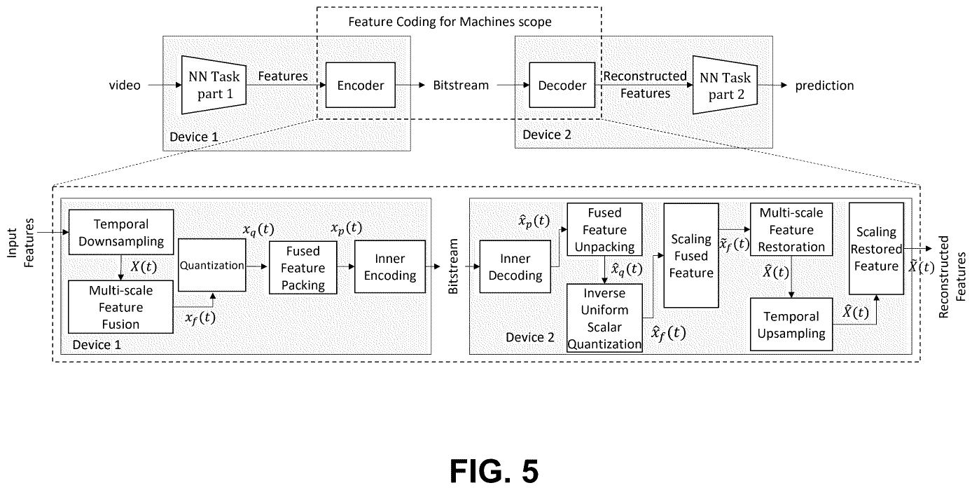

FIG. 5 shows an example pipeline associated with video processing. Examples described herein may be associated with parts of the split DNN model, NN Task Part 1 and NN Task Part2, as shown in FIG. 5. The parts may be run on different devices, e.g., NN Task Part 1 on a phone or camera and NN Task Part 2 on the network or cloud, for example. Such splitting of the model may be used to offload computations when the device that captures or contains the source content has a (e.g., has a particular) processing capacity, memory capacity, energy capacity, etc. Splitting of the model may be associated with transmitting such features while protecting the privacy of the original content, as the original pixels may not be directly coded. At the split point, intermediate data or features may be transmitted to the remote machine to perform the second part of the model inference.

The device including the source video may perform NN Task Part 1 to extract features. The features may be transmitted and analyzed remotely by NN Task Part 2. The data volume of the feature tensor(s) may be greater than input data volume. Video coding may be associated with reducing the size of the feature bitstream to enable the transmission over bandwidth networks. Video coding may be used for natural scene, graphic content, etc. in 2-dimensional input data for human visual system. Video coding may be associated with compressing the computed features in a shape of 3 dimension (3D) over first layers of a DNN for machine vision tasks. Examples described herein may be associated with compression for intermediate feature tensors in the context of split inference scenario.

The zoomed-in dashed block in FIG. 5 presents compression modules composing an example coding pipeline. To compress the input features

$$X ( t ) = {\{ {x}_{n} ( t ) \}}_{n = 1}^{N} ,$$

where N is the number of feature tensors with 3-dimension (3D) at time t, from the NN Task Part1, an encoder may drop a set (e.g., every other set) of input feature tensors if the temporal downsampling is enabled. In examples described herein, a set of tensors or picture may refer to input feature tensors for a given time instant, corresponding to a picture of a video. The non-dropped feature input X(t) at time t may be fed into the multi-scale feature fusion and fused into a single tensor x_{f}(t). The multi-scale feature fusion may be a NN-based module that is trained offline to fuse and significantly reduce the dimensions of the input tensors. At the feature conversion stage, the fused feature channels may be quantized with q-bit, tiled and packed onto a 2D frame xₚ(t). The order of the modules in the conversion stages may be swappable. The packed frame with the quantized features xₚ(t) may be encoded in vide data (e.g., a bitstream).

On the remote server, an inner decoder, e.g. the 2D video codec, may take the bitstream as input and reconstruct the tiled frame \hat{x}ₚ(t). The reconstructed tiled frame \hat{x}ₚ(t) may be reshaped into 3D feature tensors \hat{x}_{q}(t) via fused feature unpacking module. The inverse uniform scalar quantization may be applied to \hat{x}_{q}(t) to get \hat{x}_{f}(t) in the range 0 to 1.0, for example. Using \hat{x}_{f}(t) as input, the scaling fused feature module, which may be present at the decoder, may scale \hat{x}_{f}(t) to have a standard deviation of 1 and a mean of 0 (e.g., Z-score normalization), and re-scale back using transmitted statistical parameters of mean and standard deviation for the original x_{f}(t). Scaled \tilde{x}_{f}(t) with the transmitted mean and standard deviation may be fed into the multi-scale feature restoration module. The neural network-based restoration module may reconstruct the multiple feature tensors

$$\hat{X} ( t ) = {\{ {\hat{x}}_{n} ( t ) \}}_{n = 1}^{N}$$

that corresponds to the interface with the split point(s). When a temporal upsampling module is enabled, the reconstructed \hat{X}(t) may be buffered (e.g., until the next \hat{X}(t+2) is reconstructed) to estimate \hat{X}(t+1) with bilinear interpolation. Regardless of the activation of upsampling, the output of the temporal upsampling, \hat{X}(t) may be scaled by the scaling module scaling restored feature which is performed at the decoder, using the transmitted global mean and standard deviation of X. The re-scaled feature tensors

$$\tilde{X} ( t ) = {\{ {\tilde{x}}_{n} ( t ) \}}_{n = 1}^{N}$$

may be used as an input to the NN Task Part 2 to complete the inference of the machine task. In examples, the variable time t may be omitted to discuss different parts of the modules composing a video coding pipeline.

The pre-trained NN-task-part-1 and NN-task-part-2 may (or may not) be trained with an entropy constraint on the intermediate features. Computer vision algorithms may be trained to maximize accuracy. A feature map (e.g., channels) computed through learned computer vision network may contribute to the end accuracy, whatever the coding cost.

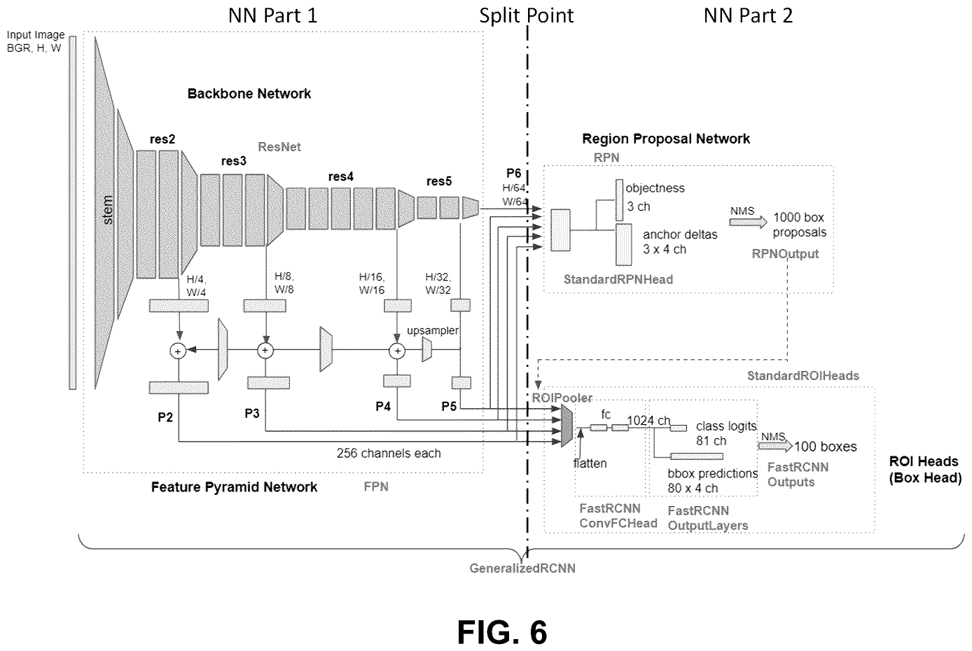

FIG. 6 shows an example region-based convolutional neural network (R-CNN) architecture. The model may include a backbone that generates feature tensors of different sizes P2, P3, P4, P5, P6, that are analyzed for tasks such as object detection and segmentation. In the split-inference context, a split point may, for example, be a split that separates NN-part-1 and NN-part-2 in FIG. 5, where the encoded and transmitted data correspond to tensors X={x₁=P2, x₂=P3, x₃=P4, x₄=P5}.

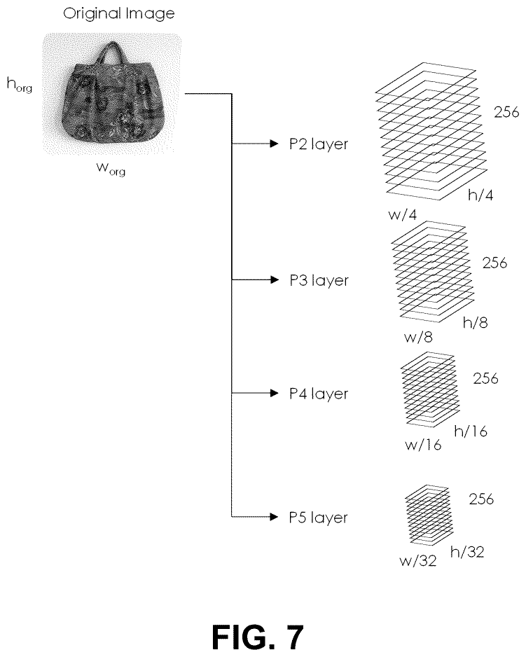

FIG. 7 illustrates example shapes of tensors to transmit, considering a split point after a backbone network of an example R-CNN architecture. The shapes of these tensors to transmit are detailed in FIG. 7. The tensors may include 256 channels for an input image, and resolutions depending on the input resolution (e.g., the input resolution to the model may be different from the original image size worg×horg due to rescaling and padding operations).

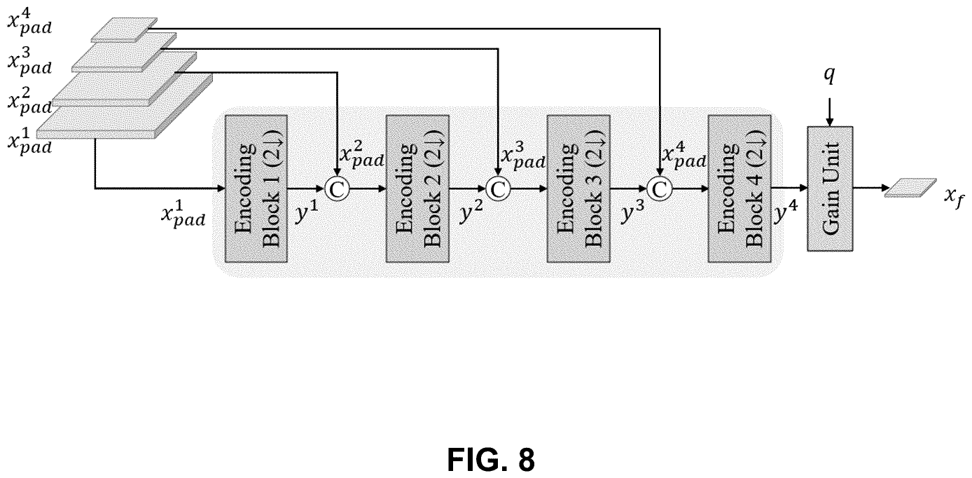

The extracted feature tensors out of the NN Part 1 in the example R-CNN may be fed into the multi-scale feature fusion model shown in FIG. 8, where P2, P3, P4, P5 are represented by

$${x}_{pad}^{1} , {x}_{pad}^{2} , {x}_{pad}^{3} , {x}_{pad}^{4} ,$$

respectively. Because of spatial shift (e.g., by nature of the convolution operation), a feature tensor may be padded (e.g., before applying the convolutional layers).

FIG. 8 shows an example shallow network architecture for a feature reduction module interfacing with an example R-CNN at example feature pyramid network outputs P2, P3, P4, P5. In FIG. 8, the set of feature tensors may be converted into a single feature tensor with 320 channels, y⁴ using convolutional layers with learned weights. A gain unit may adjust the scales of the feature tensor y⁴ by multiplying each channel by a one of the 8 learned candidate vectors and outputs the reduced feature tensor x_{f}∈ [symbol] ^{C}^{_{f}}^{×H}^{_{f}}^{×W}^{_{f}} where C_{f}=320 and H_{f}×W_{f} is the spatial resolution of the feature tensor. The index of the vector, q, as input to the Gain Unit may be heuristically selected or fixed.

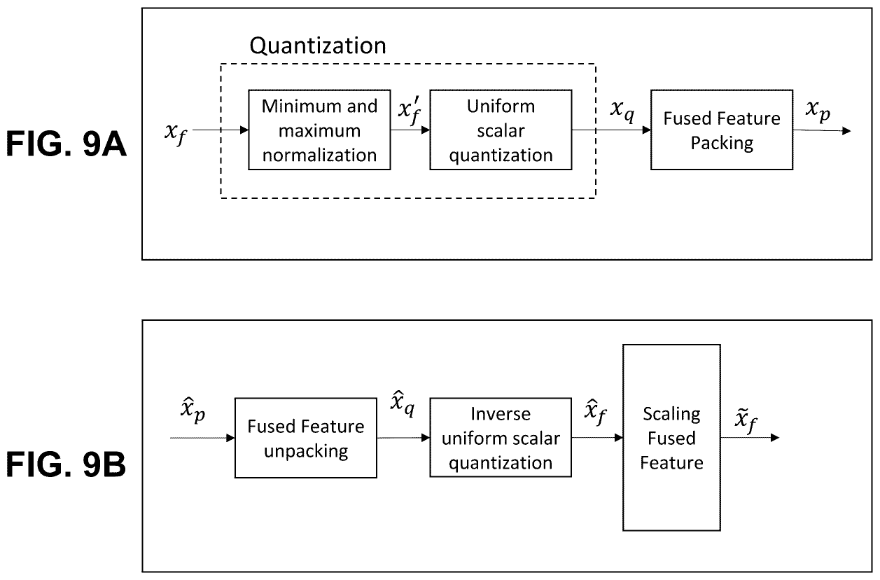

FIG. 9A shows an example feature conversion. FIG. 9B shows an example inverse feature conversion. To utilize video codecs to encode the reduced feature tensor x_{f} that has 3 dimensions, the fused feature packing module may conduct the reshaping of the 3D tensor into 2D frame xₚ, followed by quantization. FIG. 9A shows an example feature conversion consisting of the normalization followed by the uniform scalar quantization and fused feature packing. For the inverse conversion as shown in FIG. 9B, there is fused feature unpacking followed by the inverse uniform scalar quantization and scaling fused feature module. The order between the quantization and fused feature packing may be swappable.

For a fused feature tensor x_{f} fused by the multi-scale feature fusion module, the minimum and maximum values of the feature tensors, x_{f,min} and x_{f,max} may be computed and used to normalize the feature values between 0 and 1 as follows:

$${x}_{f}^{′} = max ( min ( \frac{{x}_{f} - {x}_{f , min}}{{x}_{f , max} - {x}_{f , min}} , 0 ) , 1 )$$

Then q-bit uniform scalar quantization may be applied to x_{f}′ before packing the feature channels onto a 2D frame to use as input to the standard codec:

$${x}_{q} = round ( {x}_{f}^{′} \times ( {2}^{q} - 1 ) )$$

where round( ) is the rounding operation to the nearest integer value.

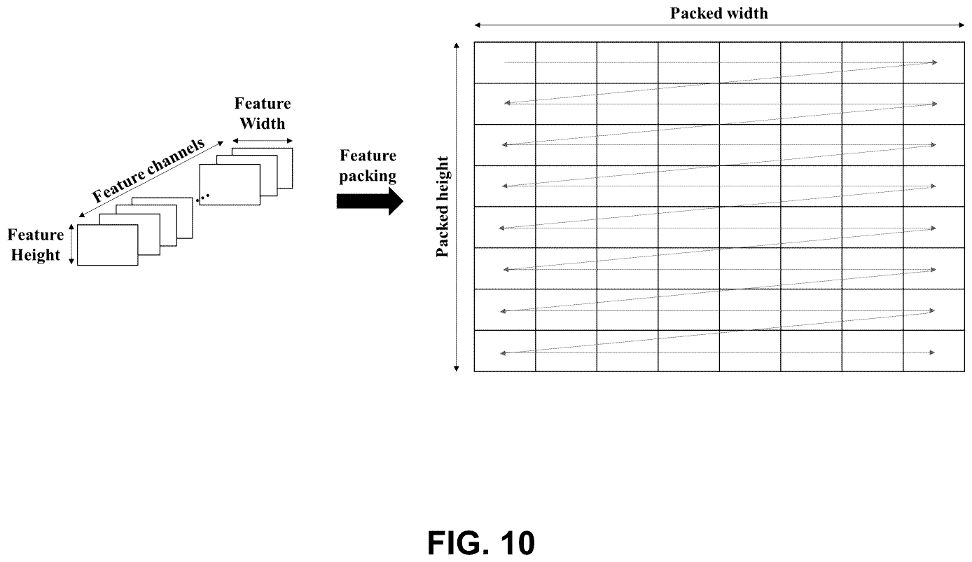

FIG. 10 shows an example of tiled feature channels into a packed frame. For the fused feature packing, the frame resolution Hₚ and Wₚ may be computed such that the shape of the packed frame becomes as wide rectangularly as possible by which C_{f} is divided in width and height and multiplied by W_{f} and H_{f}, respectively. FIG. 10 presents the (e.g., final) packed frame xₚ∈ [symbol] ^{H}^{ₚ}^{×W}^{ₚ} out of C_{f}.

The frame xₚ represented in q-bit integer may be fed into the video codec (e.g., after a conversion process). In examples, a mean and standard deviation parameters of the original features for scaling operations, feature tensor sizes, etc. may be coded and added to the bitstream. Decoding may correspond to the inverse scaling and packing operations of the encoder in inverse order, using the parsed information from the bitstream. Scaling operations may be applied at the decoder as shown in FIG. 5 and FIG. 9B.

For example, the scaling fused feature (SFF) may rescale the reconstructed fused feature tensor \hat{x}_{f}(t) with mean

$${μ}_{{\hat{x}}_{f} ( t )} = \frac{1}{J} {\sum }_{j = 1}^{J} {\hat{x}}_{f} ( t ) [ j ]$$

and standard deviation

$${σ}_{{\hat{x}}_{f} ( t )} = \sqrt{\frac{1}{J} {\sum }_{j = 1}^{J} {( {\hat{x}}_{f} ( t ) [ j ] - {μ}_{{\hat{x}}_{f} ( t )} )}^{2}} ,$$

where J=C_{f}H_{f}W_{f}. The scaling operation may apply Z-score normalization followed by inverse normalization to \hat{x}_{f}(t) order to obtain the rescaled fused feature tensor \tilde{x}_{f}(t), as follows:

$${\tilde{x}}_{f} ( t ) = ( \frac{{\hat{x}}_{f} ( t ) - {μ}_{{\hat{x}}_{f} ( t )}}{{σ}_{{\hat{x}}_{f} ( t )}} ) \times {σ}_{{x}_{f} ( {kL}_{SFF} )} + {μ}_{{x}_{f} ( {kL}_{SFF} )} ,$$

where μₓ_{_{f}}_{(kL}_{_{SFF}}₎ and σₓ_{_{f}}_{(kL}_{_{SFF}}₎ are the transmitted mean and standard deviation of original x_{f} from encoder at time kL_{SFF} where k=0, 1, 2, 3, . . . and L_{SFF} is an update period of the mean and standard deviation (e.g., every intra frame) for the SFF module.

The scaling restored feature (SRF) may rescale the set of the reconstructed restored feature tensors \hat{X}(t) with mean

$${μ}_{\hat{X} ( t )} = {\sum }_{n = 1}^{N} {μ}_{{\hat{x}}_{n} ( t )}$$

and standard deviation

$${σ}_{\hat{X} ( t )} = \sqrt{{\sum }_{n = 1}^{N} {σ}_{{\hat{x}}_{n} ( t )}^{2}} ,$$

where μ_{\hat{x}}_{ₙ}₍ₜ₎ and σ_{\hat{x}}_{ₙ}₍ₜ₎ are the mean and standard deviation of \hat{x}ₙ(t). The scaling operation may apply a Z-score normalization and (e.g., followed by) inverse normalization to individual restored feature tensor \hat{x}ₙ(t) to obtain the rescaled restored feature tensors

$$\tilde{X} ( t ) = {\{ {\tilde{x}}_{n} ( t ) \}}_{n = 1}^{N} ,$$

as follows:

$${\tilde{x}}_{n} ( t ) = ( \frac{{\hat{x}}_{n} ( t ) - {μ}_{\hat{X} ( t )}}{{σ}_{\hat{x} ( t )}} ) \times {σ}_{X ( {kL}_{SRF} )} + {μ}_{X ( {kL}_{SRF} )} ,$$

where

$${μ}_{{X ( {kL}_{SRF} )}^{=}} {\sum }_{n = 1}^{N} {μ}_{{x}_{n} ( {kL}_{SRF} )} and {σ}_{X ( {kL}_{SRF} )} = \sqrt{{\sum }_{n = 1}^{N} {σ}_{{x}_{n} ( {kL}_{SRF} )}^{2}}$$

are the transmitted representative mean and standard deviation of original X from the encoder at time kL_{SRF}, and L_{SRF} is an update period of the mean and standard deviation (e.g., every intra frame) for the SRF module.

In examples, restored_feat_refine_refresh_period may be used for L_{SRF} and fused_feat_refine_refresh_period may be used for L_{SFF} signaled in 8 bits in FSPS when the scaling methods are enabled and signaled in a feature sequence parameter set (FSPS), as shown in Table 1. In examples described herein, an FSPS and a feature picture parameter set (FPPS) may be used interchangeably.

TABLE 1
feature sequence parameter set (FSPS)

| | Descriptor |
|---|---|
| feat_seq_parameter_set_rbsp ( ) { | |
| fsps_feat_seq_parameter_set_id | |
| ... | |
| ... | |
| temporal_upsampling_enable_flag | u(1) |
| restored_feat_refine_flag | u(1) |
| fused_feat_refine_flag | u(1) |
| if (restored_feat_refine_flag ) { | |
| restored_feat_refine_refresh_period | u(8) |
| } | |
| if(fused_feat_refine_flag) { | |
| fused_feat_refine_refresh_period | u(8) |
| } | |
| rbsp_trailing_bits( ) | |
| } | |

The statistical parameters of restored_feat_mean and restored_feat_std (μ_{X(kL}_{_{SRF}}₎, σ_{X(kL}_{_{SRF}}₎) and fused_feat_mean and fused_feature_std (μₓ_{_{f}}_{(kL}_{_{SFF}}₎, σₓ_{_{f}}_{(kL}_{_{SFF}}₎) may be computed from the encoder side and signaled in feature picture parameter set (FPPS) in a period of L_{SFF} and L_{SRF}, respectively, as shown in Table 2. Based on Table 2, the condition to update the parameters may check if the remainder of the VVC::PicOrderCntVal divided by the refresh period is equal to 0.

TABLE 2
feature picture parameter set (FPPS)

Descriptor

```
feature_pic_parameter_set_rbsp( ) {
  fpps_feat_pic_parameter_set_id
  fpps_feat_seq_parameter_set_id
  if( !dequant_bypass_flag ) {
```

| | ... |
|---|---|
| } | |
| if( !unpacking_bypass_flag ) { | |
| | ... |

| | |
|---|---|
| } | |
| if(restored_feat_refine_flag ) { | |
| if( VVC::PicOrderCntVal % | |
| restored_feat_refine_refresh_period == 0 ) { | |
| restored_feat_std | bf(16) |
| restored_feat_mean | bf(16) |
| } | |
| } | |
| if(fused_feat_refine_flag ) { | |
| if( VVC::PicOrderCntVal % | |
| fused_feat_refine_refresh_period == 0 ) { | |
| fused_feat_std | f(32) |
| fused_feat_mean | f(32) |
| } | |
| } | |
| rbsp_trailing_bits( ) | |
| } | |

Features described herein may be associated with video coding for machine(s), feature compression, deep learning, video bitstreams, etc. In examples, parameters included in feature picture parameter sets (FPPS) may be updated (e.g., regardless of the use of temporal resampling). In examples, the decoder count and identification of the picture order count (POC) of the incoming decoding frames may be used to derive the refreshing of parameters.

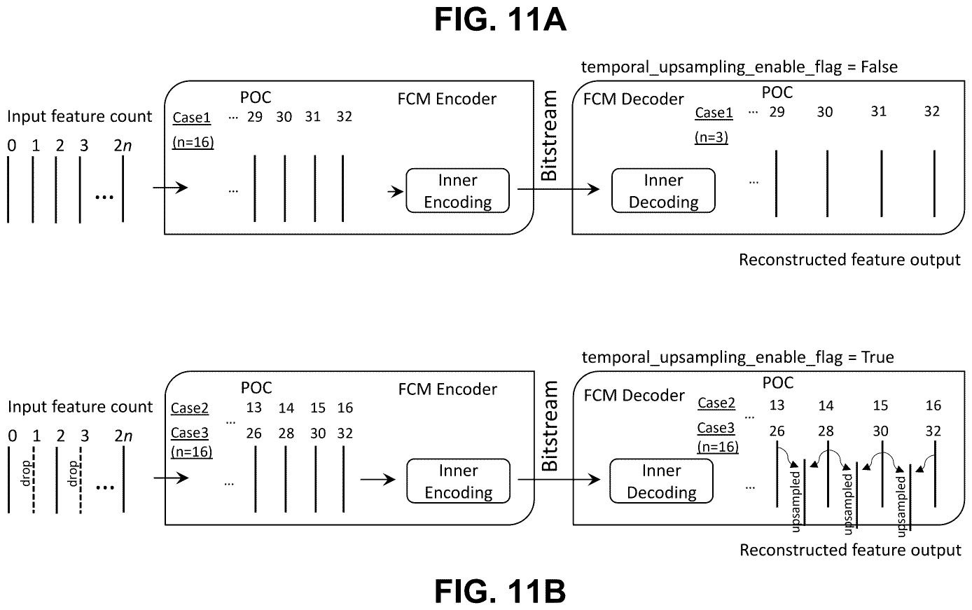

FIG. 11A shows an example of a coding sequence at the encoder and decoder when the temporal upsampling is disabled. FIG. 11B shows an example of a coding sequence at the encoder and decoder when the temporal upsampling is enabled. Examples described herein may be associated with supporting the refreshment of picture level parameters at any given picture, by comparing two scenarios of coding sequence order at both the encoder and decoder with temporal upsampling disabled in (a) and enabled in (b).

When temporal upsampling is disabled (e.g., no temporal downsampling in performed at the encoder), the POC may follow the coding order as depicted in FIG. 11A. Parameter updates in FPPS may be done at the decoder by identifying the remainder of decoded POC divided by the corresponding refresh periods of parameters such as L_{SFF}, L_{SRF} or a refresh period for parameters are update with a given refresh period. For example, restored_feat_std and restored_feat_mean may be updated every 32 pictures, indicating that restored_feat_refine_refresh_period==L_{SRF}==32. Based on POC==32, the remainder of POC % L_{SRF} may be equal to 0, the updated restored_feat_std and restored_feat_mean may be parsed from the FPPS to be updated and referenced by the corresponding picture with POC==32.

FIG. 11B shows an example of a temporal down-sampling truncating pictures (e.g., every other picture) at the encoder. An encoder may sequentially assign the picture order count (POC) from 0 increased by 1 for the temporally down-sampled input (e.g., Case 2) or may assign the POC with the original count of the input pictures (e.g., Case 3). An inner encoder (e.g., HEVC, VVC) may be configured to follow the same POC assignment when temporal upsampling is enabled. For case 2, the encoder may request to update restored_feat_std and restored_feat_mean every L_{SRF}==32 pictures. Due to the temporal downsampling, the parsed POC corresponding the 32nd picture may be equal to 16. The remainder of POC % L_{SRF}==16. Since the remainder is not equal to 0, restored_feat_std and restored_feat_mean in FPPS corresponding to the decoded picture may not be parsed and updated.

The gap of 1 may be identified between consecutive POCs when temporal resampling is enabled, so that at the decoder, POCs are multiplied by 2. The remainder of POC % L_{SRF} may become 0, and the restored_feat_std and restored_feat_mean in FPPS may be correctly parsed and updated. The current design may rely on the difference of POC between two consecutive pictures being equal to 1 to distinguish between examples described herein. In examples including corners, the difference of POC between two consecutive pictures may be naturally equal to 1, which may not activate the computation of POC multiplied by 2.

In some examples, parameter updates may occur over a period of time through FPPS. FPPS may be updated by relying on the remainder of POC divided by a coded refresh period. In some examples, an indication may be included in video data to indicate whether the corresponding parameters are to be updated in FPPS. The signaling related to the refresh periods may be skipped. The methods described herein may apply to other parameter updates through FPPS.

An encoder may or may not retain the POCs with the original counts of input pictures, as the POCs may be obtained in order. Examples described herein may be associated with removing’ the dependency on the potentially mismatching POC calculations and parameter refresh period at the decoder. An indication may be introduced in the FPPS to indicate if corresponding parameters are to be parsed and updated. The FSPS may be updated accordingly, as indicated in Table 3.

TABLE 3
syntax table for feature sequence parameter set (FSPS)

| | Descriptor |
|---|---|
| feat_seq_parameter_set_rbsp ( ) { | |
| fsps_feat_seq_parameter_set_id | |
| ... | |
| ... | |
| temporal_upsampling_enable_flag | u(1) |
| restored_feat_refine_flag | u(1) |
| fused_feat_refine_flag | u(1) |
| rbsp_trailing_bits( ) | |
| } | |

In examples, an indication may indicate a presence of update parameters in FPPS. Table 4 shows the updates of FPPS in which the condition that refers to POC to determine the presence of refinement parameters is replaced with a signaled indication explicitly indicating the presence of the refinement parameters in the FPPS. The FSPS may be updated accordingly, as shown in Table 4.

TABLE 4
syntax table for feature picture parameter set (FPPS)

Descriptor

```
feature_pic_parameter_set_rbsp( ) {
  fpps_feat_pic_parameter_set_id
  fpps_feat_seq_parameter_set_id
  if( !dequant_bypass_flag ) {
```

| | ... |
|---|---|
| } | |
| if( !unpacking_bypass_flag ) { | |
| | ... |

| | |
|---|---|
| } | |
| if(restored_feat_refine_flag) { | |
| fpps_restored_feature_refinement_update_flag | u(1) |
| if(fpps_restored_feature_refinement_update_flag) { | |
| restored_feat_std | bf(16) |
| restored_feat_mean | bf(16) |
| } | |
| } | |
| if(fused_feat_refine_flag) { | |
| fpps_fused_feature_refinement_update_flag | u(1) |
| if(fpps_fused_feature_refinement_update_flag) { | |
| fused_feat_std | f(32) |
| fused_feat_mean | f(32) |
| } | |
| } | |
| ... | |
| rbsp_trailing_bits( ) | |
| } | |

Indication fpps_restored_feature_refinement_update_flag equal to 1 may specify that the parameters restored_feat_std and restored_feat_mean are updated. When fpp_restored_feature_refinement_update_flag is equal to 1 while restored_feature_refine_flag is enabled at FSPS, restored_feat_std and restored_feat_mean may be parsed. The restored feature refinement process may use the updated parameters for pictures referring to the FPPS associated with fpps_feat_pic_parameter_set_id. If fpp_restored_feature_refinement_update_flag is equal to 0, update parameters may (or may not) be parsed.

Indication fpps_fused_feature_refinement_update_flag equal to 1 may specify that the parameters updates of fused_feat_std and fused_feat_mean are updated. When fpp_fused_feature_refinement_update_flag is equal to 1 while fused_feature_refine_flag is enabled at FSPS, fused_feat_std and fused_feat_mean may be parsed. The fused feature refinement process may use the updated parameters for pictures referring to the FPPS associated with fpps_feat_pic_parameter_set_id. If fpp_fused_feature_refinement_update_flag is equal to 0, update parameters may (or may not) be parsed.

Features described herein may be associated with tools that involve the parameter updates with a (e.g., certain) period of time. For example, there may be a tool that involves POC and a (e.g., certain) refresh period to derive a condition which activates parsing the coded parameters, as shown in lines between 24 and 44 in Table 5. The condition of the tool may be described as updated in Table 6.

TABLE 5
Example syntax table for feature picture parameter set (FPPS) with an example coding tool

| | | | Descriptor |
|---|---|---|---|
| Line | feature_pic_parameter_set_rbsp( ) { | | |
| 1 | fpps_feat_pic_parameter_set_id | | |
| 2 | fpps_feat_seq_parameter_set_id | | |
| 3 | if( !dequant_bypass_flag ) { | | |
| 4 | | ... | |
| 5 | } | | |
| 6 | if( !unpacking_bypass_flag ) { | | |
| 7 | | ... | |

| | | |
|---|---|---|
| 8 | } | |
| 9 | ... | |
| 10 | if(restored_feat_refine_flag) { | |
| 11 | fpps_restored_feature_refinement_update_flag | u(1) |
| 12 | if(fpps_restored_feature_refinement_update_flag) { | |
| 13 | restored_feat_std | bf(16) |
| 14 | restored_feat_mean | bf(16) |
| 15 | } | |
| 16 | } | |
| 17 | if(fused_feat_refine_flag) { | |
| 18 | fpps_fused_feature_refinement_update_flag | u(1) |
| 19 | if(fpps_fused_feature_refinement_update_flag) { | |
| 20 | fused_feat_std | f(32) |
| 21 | fused_feat_mean | f(32) |
| 22 | } | |
| 23 | } | |
| 24 | update_channel_dynamic_range_adjustment_parameters = 0 | |
| 25 | if (fsps_channel_dynamic_range_adjustment_refresh_period == 0) { | |
| 26 | if ((POC == 0 or nal_unit_type == IDR picture) { | |
| 27 | update_channel_dynamic_range_adjustment_parameters = 1 | |
| 28 | } | |
| 29 | else { | |
| 30 | if ( (POC == 0 or nal_unit_type == IDR picture or | |
| | (POC % fsps_channel_dynamic_range_adjustment_refresh_period) | |
| | == 0) { | |
| 31 | update_channel_dynamic_range_adjustment_parameters = 1 | |
| 32 | } | |
| 33 | if(fsps_channel_dynamic_range_adjustment_flag and | |
| | update_channel_dynamic_range_adjustment_parameters == 1) { | |
| 34 | fpps_cdra_most_probable_scale_minus_3 | u(3) |
| 35 | fpps_cdra_single_scale_flag | u(1) |
| 36 | if (!fpps_cdra_single_scale_flag) { | |
| 37 | for (i = 0 ; i < fsps_number_of_fused_feature_channels; i++) { | |
| 38 | fpps_cdra_mps_flag | u(1) |
| 39 | if ( !fpps_cdra_mps_flag) { | |
| 40 | fpps_cdra_scale_minus_3[i] | u(3) |
| 41 | } | |
| 42 | } | |
| 43 | } | |
| 44 | } | |
| 45 | rbsp_trailing_bits( ) | |
| 46 | } | |

TABLE 6
Example syntax table for feature picture parameter
set (FPPS) with an example coding tool

| | | | Descriptor |
|---|---|---|---|
| Line | feature_pic_parameter_set_rbsp( ) { | | |
| 1 | fpps_feat_pic_parameter_set_id | | |
| 2 | fpps_feat_seq_parameter_set_id | | |
| 3 | if( !dequant_bypass_flag ) { | | |
| 4 | | ... | |
| 5 | } | | |
| 6 | if( !unpacking_bypass_flag ) { | | |
| 7 | | ... | |

| | | |
|---|---|---|
| 8 | } | |
| 9 | ... | |
| 10 | if(restored_feat_refine_flag) { | |
| 11 | fpps_restored_feature_refinement_update_flag | u(1) |
| 12 | if(fpps_restored_feature_refinement_update_flag) { | |
| 13 | restored_feat_std | bf(16) |
| 14 | restored_feat_mean | bf(16) |
| 15 | } | |
| 16 | } | |
| 17 | if(fused_feat_refine_flag) { | |
| 18 | fpps_fused_feature_refinement_update_flag | u(1) |
| 19 | if(fpps_fused_feature_refinement_update_flag) { | |
| 20 | fused_feat_std | f(32) |
| 21 | fused_feat_mean | f(32) |
| 22 | } | |
| 23 | } | |
| 24 | if(fsps_channel_dynamic_range_adjustment_flag) { | |
| 25 | fpps_channel_dynamic_range_adjustment_update_flag | u(1) |
| 26 | if(fpps_channel_dynamic_range_adjustment_update_flag) { | |
| 27 | fpps_cdra_most_probable_scale_minus_3 | u(3) |
| 28 | fpps_cdra_single_scale_flag | u(1) |
| 29 | if (!fpps_cdra_single_scale_flag) { | |
| 30 | for (i = 0 ; i < fsps_number_of_fused_feature_channels; i++) { | |
| 31 | fpps_cdra_mps_flag | u(1) |
| 32 | if ( !fpps_cdra_mps_flag) { | |
| 33 | fpps_cdra_scale_minus_3[i] | u(3) |
| 34 | } | |
| 35 | } | |
| 36 | } | |
| 37 | } | |
| 38 | } | |
| 39 | rbsp_trailing_bits( ) | |
| 40 | } | |

Indication fpps_channel_dynamic_range_adjustment_update_flag being equal to 1 may specify that there is syntax to parse to update channel dynamic range adjustment related parameters while fsps_channel_dynamic_range_adjustment_flag is enabled. The channel dynamic range adjustment process may use the updated used for the channel dynamic range adjustment parameters for pictures referring to the FPPS associated with fpps_feat_pic_parameter_set_id. If fpps_channel_dynamic_range_adjustment_update_flag is equal to 0, syntax may (or may not) be parsed.

In examples, an indication to indicate the presence of updated parameters in FPPS may (or may not) be sent (e.g., conditions that refer to POC to determine the presence of refinement parameters, as shown in Table 7, may (or may not) be present).

TABLE 7
syntax table for feature picture parameter set (FPPS) with a coding tool

| | | | Descriptor |
|---|---|---|---|
| Line | feature_pic_parameter_set_rbsp( ) { | | |
| 1 | fpps_feat_pic_parameter_set_id | | |
| 2 | fpps_feat_seq_parameter_set_id | | |
| 3 | if( !dequant_bypass_flag ) { | | |
| 4 | | ... | |
| 5 | } | | |
| 6 | if( !unpacking_bypass_flag ) { | | |
| 7 | | ... | |

| | | |
|---|---|---|
| 8 | } | |
| 9 | ... | |
| 10 | if(restored_feat_refine_flag) { | |
| 11 | restored_feat_std | bf(16) |
| 12 | restored_feat_mean | bf(16) |
| 13 | } | |
| 14 | if(fused_feat_refine_flag) { | |
| 15 | fused_feat_std | f(32) |
| 16 | fused_feat_mean | f(32) |
| 17 | } | |
| 18 | if(fsps_channel_dynamic_range_adjustment_flag) { | |
| 19 | fpps_cdra_most_probable_scale_minus_3 | u(3) |
| 20 | fpps_cdra_single_scale_flag | u(1) |
| 21 | if (!fpps_cdra_single_scale_flag) { | |
| 22 | for (i = 0 ; i < fsps_number_of_fused_feature_channels; i++) { | |
| 23 | fpps_cdra_mps_flag | u(1) |
| 24 | if ( !fpps_cdra_mps_flag) { | |
| 25 | fpps_cdra_scale_minus_3[i] | u(3) |
| 26 | } | |
| 27 | } | |
| 28 | } | |
| 29 | } | |
| 30 | rbsp_trailing_bits( ) | |
| 31 | } | |

Features described herein may be associated with ecosystems involving the transmission of data for machine vision consumption (e.g., compression of intermediate data in split-DNN model pipelines where the split-DNN model is trained for machine vision tasks). A type of intermediate data from various learned models including vision, natural language processing, and multi-modal processing may be coded.

In examples, a video coding device (e.g., a video decoding device) may receive an FSPS and FPPS and determine that the presence of a coding parameter is indicated. The presence of a coding parameter in the FPPS may be indicated, for example, by a tool enable indication. The coding parameter may include one or more of a restored feature, a fused feature, or a dynamic range adjustment. The device may parse the one or more parameters and use them for reconstructing a feature(s) for decoding, such as a restored feature, a fused feature, or a channel dynamic range adjustment, respectively. The presence of the coding parameters may be indicated, for example, regardless of POC conditions and/or regardless of receiving an update indication.

In examples, a video coding device (e.g., a video encoding device) may generate an FSPS and FPPS and signal the presence of a coding parameter. The presence of a coding parameter in the FPPS may be indicated, for example, by a tool enable indication included in the FSPS. The coding parameter may include one or more of a restored feature, a fused feature, or a dynamic range adjustment. The device may encode the one or more parameters and include them in the FPPS for transmission, enabling the reconstruction of feature(s) for decoding, such as a restored feature, a fused feature, or a channel dynamic range adjustment, respectively. The presence of the coding parameters may be signaled, for example, regardless of POC conditions and/or without requiring an explicit update indication.

The one or more feature refinement indications may include a restored feature refinement indication. Determining that the one or more refinement parameters are present may include identifying that restored_feat_std and restored_feat_mean parameters are included in the FPPS.

The one or more feature refinement indications may include a fused feature refinement indication, and determining that one or more refinement parameters are present may include identifying that fused_feat_std and fused_feat_mean parameters are included in the FPPS.

The one or more feature refinement indications may include a channel dynamic range adjustment indication, and determining that one or more refinement parameters are present may include identifying that channel dynamic range adjustment parameters are included in the FPPS.

The device may reconstruct a feature of a decoded picture based on the parsed refinement parameters.

One or more embodiments provide a computer program comprising instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various methods and aspects described herein can be used to modify one or more modules. For example, the intra predictors and inter predictors described with respect to FIGS. 2 and 3 may be implemented as one or more modules and modified according to the various embodiments of the present disclosure.

The various embodiments described herein provide at least the following features, devices or aspects, alone or on any combination, across various claim categories and types:
i. Encoding, into coded video data, syntax elements that can enable the decoder to decode the coded video data, according to any of the embodiments described herein.
ii. Video data (e.g., a bitstream) that may include one or more of the described syntax elements, or variations thereof, whether transmitted, stored, or otherwise made available.
iii. Creating, transmitting, receiving, and/or decoding of the bitstream.
iv. An electronic device (e.g., TV, set-top box, mobile phone, tablet, etc.) that tunes a channel to receive a bitstream or that receives such bitstream over the air. The electronic device decodes the syntax elements from the bitstream, and, optionally, displays (e.g., via a monitor or other type of display) a resulting image.

Various numeric values are used in the present application. Such specific values are for example purposes and the embodiments described are not limited to these specific values.

Various methods are described herein, and such methods comprise one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present disclosure may refer to “determining” various pieces of information. Determining information may include one or more of, for example, estimating, calculating, predicting, or retrieving (e.g., from memory) the information.

The present disclosure may refer to “accessing” various pieces of information. Accessing information may include one or more of, for example, receiving, retrieving (e.g., from memory), storing, moving, copying, calculating, determining, predicting, or estimating the information. Similarly, the present disclosure may refer to “receiving” various pieces of information. Receiving information may include one or more of, for example, accessing or retrieving (e.g., from memory) the information.

“Decoding,” as used herein, encompasses all or part of the processes performed, for example, on an encoded sequence to produce an output suitable for display. In some embodiments, such processes include one or more of the processes typically performed by a decoder, for example, entropy decoding, inverse quantization, etc. Whether the phrase “decoding process” is intended to refer to a subset of operations or generally to the broader decoding process will be clear based on the context of the specific description and will be well understood by those skilled in the art.

“Encoding,” as used herein, encompasses all or part of the processes performed, for example, on input video data in order to produce an encoded bitstream. Additionally, the terms “reconstructed” and “decoded” may be used interchangeably, the terms “encoded” or “coded” may be used interchangeably, the terms “image,” “picture,” “sub-picture,” “slice,” and “frame” may be used interchangeably, and the terms “pixel” and “sample” may be used interchangeably.

The present disclosure refers to information, for example, syntax elements, which can be transmitted or stored. Such information can be packaged or arranged in a variety of manners, including for example manners common in video standards such as putting the information into a sequence parameter set (SPS), a picture parameter set (PPS), a network abstraction layer (NAL) unit, a header (for example, a NAL unit header, or a slice header), or an SEI message. Other manners are also available, including, for example, manners that are common for system level or application-level standards such as signaling the information into one or more of the following:
i. session description protocol (SDP), for example as described in RFCs and/or used in conjunction with real-time transport protocol (RTP) transmission.
ii. hypertext transfer protocol (HTTP) live Streaming (HLS) manifest transmitted over HTTP.
iii. dynamic adaptive streaming over HTTP (DASH) media presentation description (MPD) descriptors, for example as used in DASH and transmitted over HTTP.
iv. RTP header extensions, for example as used during RTP streaming.
v. International Organization for Standardization (ISO) base media file format, for example, as used in Omnidirectional MediA Format (OMAF).

As used herein, “signal” and “signaling” refer to, among other things, indicating information to a decoder. For example, in some embodiments the encoder signals a quantization matrix for de-quantization, whereby the same parameter may be used for both encoding and decoding. In some embodiments, the signaling may be explicit, such that information (e.g., a particular parameter) is transmitted to the decoder enabling the decoder to use the same particular parameter. In some embodiments, the signaling may be implicit, in that the information (e.g., a particular parameter) is indicated based on other information at or transmitted to the decoder or derived or selected by the decoder based on information available at the decoder. By not transmitting the information (e.g., the particular parameter), bit savings is thus realized in some embodiments. In some embodiments, one or more syntax elements, indications, or flags are used to signal information to a decoder. While the preceding relates to the verb form of the word “signal”, the word “signal” can also be used herein as a noun.

In some embodiments, signals may be produced that are formatted to carry information that may be stored or transmitted. Such information may include, for example, instructions for performing a method, or data produced by one of the described implementations (e.g., a bitstream of a described embodiment). Such a signal may be formatted, for example, as an electromagnetic wave or as a baseband signal. The formatting may include, for example, encoding a data stream and modulating a carrier with the encoded data stream. The information that the signal carries may be, for example, analog or digital information. The signal may be transmitted over a variety of different wired or wireless links and may be stored on a processor-readable medium.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present disclosure or the following claims. Although features and elements are described herein in particular combinations, those of ordinary skill in the art will appreciate that such features or elements may be used alone or in any combination with the other features and elements. It is understood, therefore, that the overall teachings of the present disclosure are not limited to the particular embodiments, implementations, and examples disclosed herein, but are intended to cover variations, modifications, and alternatives as defined by the appended claims and any and all equivalents thereof.

1. A method for video decoding, the method comprising:
receiving a parameter update indication in a feature picture parameter set (FPPS);
determining, based on the parameter update indication, whether parameters in the FPPS are to be updated; and
based on the determination that the parameters are to be updated, parsing updated parameter values.

2. The method of claim 1, wherein the method further comprises:
based on the parameter update indication indicating not to update the parameters, reconstructing a feature based on parameters associated with a previous picture.

3. The method of claim 1, wherein the method further comprises:
determining, based on the parameter update indication, whether a restored feature refinement parameter is to be updated;
based on the determination that the restored feature refinement parameter is to be updated, parsing a restored feature updated parameter value; and
reconstructing a feature based on the updated restored feature refinement parameter.

4. The method of claim 1, wherein the method further comprises:
determining, based on the parameter update indication, whether a fused feature refinement parameter is to be updated;
based on the determination that the fused feature refinement parameter is to be updated, parsing a fused feature updated parameter value; and
reconstructing a feature based on the updated fused feature refinement parameter.

5. The method of claim 1, wherein the method further comprises:
determining, based on the parameter update indication, whether a dynamic range adjustment parameter is to be updated;
based on the determination that the dynamic range adjustment parameter is to be updated, parsing a dynamic range adjustment updated parameter value; and
reconstructing a feature based on the updated dynamic range adjustment parameter.

6. The method of claim 1, wherein the parameter update indication comprises a first parameter update indication and a second parameter update indication, and wherein the first parameter update indication and the second parameter update indication are received separately.

7. The method of claim 6, wherein the determination that the parameters are to be updated comprise determining that a first parameter is to be updated based on the first parameter update indication and determining that second parameter is to be updated based on the second parameter update indication, and wherein parsing the updated parameter values comprises parsing a first updated parameter value associated with the first parameter and parsing a second updated parameter value associated with the second parameter.

8. A method for video encoding, the method comprising:
determining whether parameters in a feature picture parameter set (FPPS) are to be updated;
based on the determination to update the parameters, including in an FPPS a parameter update indication; and
encoding a feature based on the parameter update indication.

9. The method of claim 8, wherein the method further comprises:
determining that the parameters are not to be updated; and
encoding a feature based on parameters associated with a previous picture.

10. The method of claim 8, wherein the method further comprises:
determining whether a restored feature refinement parameter is to be updated, wherein the parameter update indication is included in the FPPS based further on the determination that the restored feature refinement parameter is to be updated.

11. The method of claim 8, wherein the method further comprises:
determining whether a fused feature refinement parameter is to be updated, wherein the parameter update indication is included in the FPPS based further on the determination that the fused feature refinement parameter is to be updated.

12. The method of claim 8, wherein the method further comprises:
determining whether a dynamic range adjustment parameter is to be updated, wherein the parameter update indication is included in the FPPS based further on the determination that the dynamic range adjustment parameter is to be updated.

13. The method of claim 8, wherein including the parameter update indication in the feature picture parameter set (FPPS) comprises including a first parameter update indication and a second parameter update indication, and wherein the first parameter update indication and the second parameter update indication are included separately.

14. The method of claim 13, wherein determining that the parameters are to be updated comprises determining that a first parameter is to be updated and determining that a second parameter is to be updated, and wherein including the parameter update indication in the FPPS further comprises including a first updated parameter value associated with the first parameter based on determining that the first parameter is to be updated and including a second updated parameter value associated with the second parameter based on determining that the second parameter is to be updated.

15. A video decoding device comprising:
a processor configured to:
receive a parameter update indication in a feature picture parameter set (FPPS);
determine, based on the parameter update indication, whether parameters in the FPPS are to be updated; and
based on the determination that the parameters are to be updated, parse updated parameter values.

16. The device of claim 15, wherein the processor is further configured to:
based on the parameter update indication indicating not to update the parameters, reconstruct a feature based on parameters associated with a previous picture.

17. The device of claim 15, wherein the processor is further configured to:
determine, based on the parameter update indication, whether a restored feature refinement parameter is to be updated;
based on the determination that the restored feature refinement parameter is to be updated, parse a restored feature updated parameter value; and
reconstruct a feature based on the updated restored feature refinement parameter.

18. The device of claim 15, wherein the processor is further configured to:
determine, based on the parameter update indication, whether a fused feature refinement parameter is to be updated;
based on the determination that the fused feature refinement parameter is to be updated, parse a fused feature updated parameter value; and
reconstruct a feature based on the updated fused feature refinement parameter.

19. The device of claim 15, wherein the processor is further configured to:
determine, based on the parameter update indication, whether a dynamic range adjustment parameter is to be updated;
based on the determination that the dynamic range adjustment parameter is to be updated, parse a dynamic range adjustment updated parameter value; and
reconstruct a feature based on the updated dynamic range adjustment parameter.

20. The device of claim 15, wherein the parameter update indication comprises a first parameter update indication and a second parameter update indication, and wherein the first parameter update indication and the second parameter update indication are received separately.
